(19) United States
(12) Patent Application Publication
(10) Pub. No.: US 2009/0237348 A1
(43) Pub. Date: Sep. 24, 2009

(54) LIQUID CRYSTAL DEVICE DRIVING APPARATUS AND METHOD

(75) Inventor: Katsuyuki Kitamura, Fukaya-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/330,405

(22) Filed: Dec. 8, 2008

(30) Foreign Application Priority Data
Mar. 19, 2008 (JP) 2008-071715

(51) Int. Cl. G09G 3/36

(52) U.S. Cl. 345/102

(57) ABSTRACT

According to one embodiment, in an embodiment of the present invention, simultaneous lighting of fluorescent tubes constituting a backlight unit is ensured, and the value of a product is increased. An apparatus of the present invention has a first power supply module which turns on a crystal panel module a white signal supply module which supplies a white signal to the liquid crystal panel module after the first power supply module turns on the liquid crystal panel module, and a second power supply module which turns on a backlight in a fixed period of time, after the white signal supply module stops supplying the white signal.

### CROSS-REFERENCE TO RELATED APPLICATIONS

This application is based upon and claims the benefit of priority from Japanese Patent Application No. 2008-071715, filed Mar. 19, 2008, the entire contents of which are incorporated herein by reference.

### BACKGROUND

1. Field

One embodiment of the present invention relates to a liquid crystal device driving apparatus and method, and in particular to a method of driving the apparatus at power-on.

2. Description of the Related Art

A liquid crystal device is used in various products, for example, a display in a television apparatus and personal computer. In the prior art, when a television apparatus is turned on, there may be a delay in lighting some fluorescent tubes constituting a backlight unit of a liquid crystal display. This may lower the user's impression of the quality of the television apparatus.

To solve such a problem, it has been proposed that at least a part of a liquid crystal panel be set to a transmissive state for a certain period when the power is turned on, so that external light is applied to a fluorescent tube, thereby facilitating lighting of a fluorescent tube (Jpn. Pat. Appln. KOKAI Publication No. 2000-250007).

As described above, fluorescent tubes constituting a backlight unit of a liquid crystal device exhibit a delay in lighting when the power is turned on. This degrades the impression of quality of a whole device. To solve the problem, a method of controlling a liquid crystal device to a transmissive state for a certain period at power-on has been proposed. However, in this method, voltage is simply applied to a liquid crystal device, and a liquid crystal device is temporarily set to a state to pass external light, but the amount of applied external light is small.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary view showing a using state of a television apparatus 100 to which the present invention is adopted;

FIG. 2 is a view showing an exemplary configuration of a liquid crystal device of the television apparatus in FIG. 1;

FIG. 3 is a view explaining arrangement of laminated parts constituting a liquid crystal device or the television apparatus in FIG. 1;

FIG. 4 is a diagram showing a driving circuit and power supply module of a liquid crystal panel module in FIG. 3;

FIGS. 5A and 5B are views explaining a driving mode and a light transmissive state of a liquid crystal panel module;

FIG. 6 is a diagram showing the operation timing of the apparatus of the present invention;

FIGS. 7A to 7E are views explaining the operation of activating a fluorescent tube;

FIG. 8 is a diagram showing the operation timing of a related liquid crystal panel module; and

FIG. 9 is a view explaining a problem in a substance to accelerate initial generation of electrons in a fluorescent tube.

### DETAILED DESCRIPTION

Various embodiments according to the invention will be described hereinafter with reference to the accompanying drawings.

An object of an embodiment of the present invention is to provide a liquid crystal device driving apparatus and method, which ensure simultaneous lighting of fluorescent tubes constituting a backlight unit at power-on, permit shifting to a stable video display state, and increase the value of a product.

According to one aspect of the present invention, there is provided an apparatus comprising a first power supply module which turns on a normally black liquid crystal panel module or a normally white liquid crystal panel module; a signal processing module which supplies a white signal to the liquid crystal panel module after the first power supply module turns on the liquid crystal panel module; and a second power supply module which turns on a backlight after the signal processing module stops supplying the white signal.

According to the above configuration, while a white signal is being supplied, an photoelectric effect is produced for a substance to accelerate initial generation of electrons in a fluorescent tube of a backlight, thereby facilitating initial emission of electrons, lighting fluorescent tubes at a time upon power-on, and eliminating a delay in lighting of some fluorescent tubes. Further, as the backlight is turned on after stopping supply a white signal, a stable image display is realized without a flashing phenomenon.

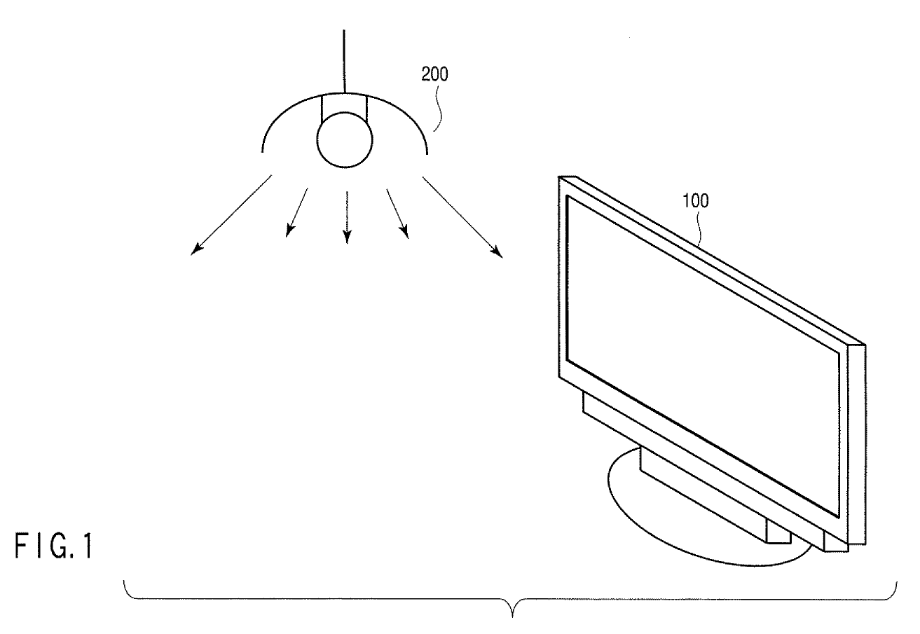

Hereinafter, embodiments of the present invention will be explained by referring to the drawings. FIG. 1 shows a television apparatus 100 to which the present invention is adopted. As shown in the drawing, the television apparatus 100 is often used under illumination of an indoor lighting fixture. In such a case, the light from a lighting fixture 200 enters the screen of The television apparatus 100. The television apparatus 100 may be used in a light room during the daytime. In such a case, the light from a window enters the screen of the television apparatus 100.

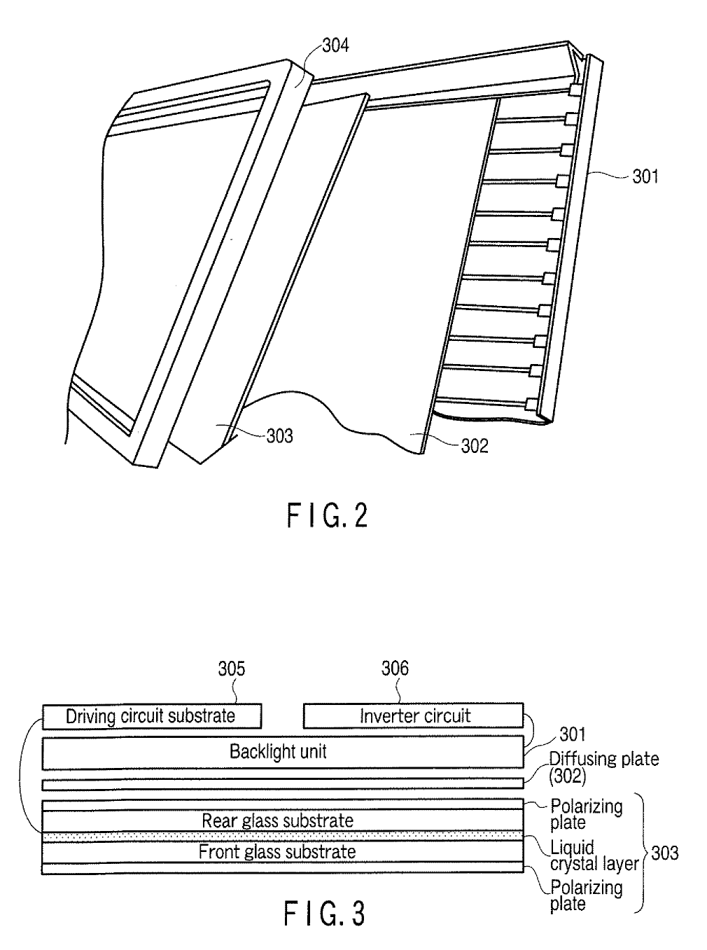

FIG. 2 shows a liquid crystal device 300 of the television apparatus 100. The liquid crystal device 300 comprises a backlight unit 301, a diffusion plate 302, a liquid crystal panel module 303, and a frame 304. The backlight unit 301, diffusion plate 302, normally black (or white) liquid crystal panel module 303 are laminated as shown in FIG. 3. At the rear of the backlight unit 301, a driving circuit substrate 305 and an inverter circuit 306 are provided.

The driving circuit substrate 305 is provided with a power supply system for the liquid crystal panel module 303, a signal supply system (an X-driver), and a timing pulse driving system (a Y-driver, and a clock output module).

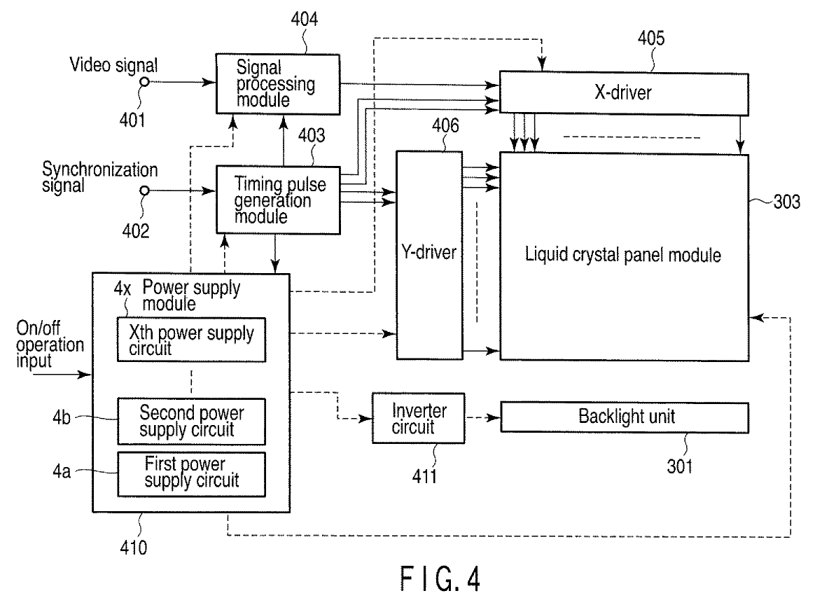

FIG. 4 shows a driving system of the liquid crystal device. A video signal is supplied to an input terminal 401, and a synchronization signal is supplied to an input terminal 402. A timing pulse generation module 403 generates a clock synchronized with the synchronization signal, as well as various timing signals.

The video data output from the signal processing module 404 is supplied to an X-driver 405. The X-driver 405 supplies data for one line to all pixel groups for one line in the liquid crystal panel module 303. Each line is selectively driven with a Y-driver 406 that is driven by a timing pulse. The X- and Y-drivers 405 and 406 are mounted on the driving circuit substrate 305.

A power supply module 410 can start supplying power to each block at the timing described later.

When the power supply module 410 is turned on, a source voltage is supplied to the signal processing module 404, timing pulse generation module 403, X-driver 405, Y-driver 406, and liquid crystal panel module 303. Here, the liquid crystal panel module 303 is assumed to be a normally black type. When the source voltage is stabilized, the timing pulse generation module 403 is started supplying a clock to the X- and Y-drivers 405 and 406. Then, the timing pulse generation module 403 controls the signal processing module 404 to output a white signal. When a white signal is given to the liquid crystal panel module 303, the liquid crystal layer of the liquid crystal panel module 303 is set to a transmissive state. Next, the timing pulse generation module 403 outputs a control pulse to turn off the white signal input. Next, the power supply module 410 turns off the backlight unit 301 through the inverter circuit 411, by the control pulse from the timing pulse generation module 403.

Therefore, the power supply module 410 includes two or more power supply circuits (may be called voltage output circuits) 4a, 4b, . . . , 4X, and can output appropriate voltage to each object block. A first power supply circuit 4a supplies voltage to the liquid crystal panel module 303, and a second power supply circuit 4b supplies voltage to the backlight 301 through the inverter circuit 411. The inverter circuit 411 is a conversion module to obtain a high voltage, and may be regarded as a part of the power supply circuit. The voltage output timing of the above-mentioned power supply circuits 4a, 4b, . . . , 4X is determined in response to the timing pulse from the timing pulse generation module 403. The timing pulse supply circuit 403 can also set the output timing of white/black signals of the signal processing module 404, and the output timing of a video signal supplied to the input terminal 401.

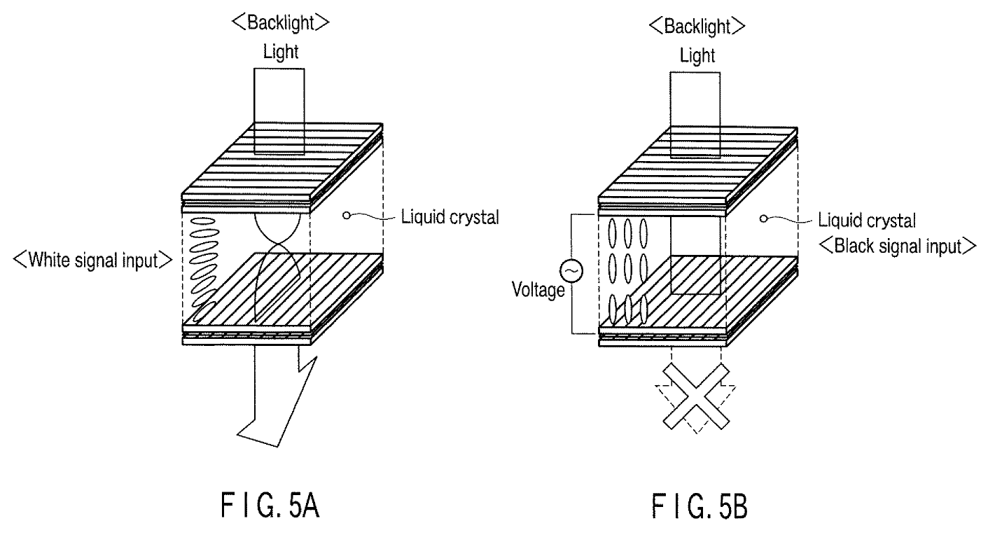

FIGS. 5A and 5B show the operation states of the liquid crystal panel module when the white signal is input and when the white signal is off (when the black signal is input). An alignment film is formed on the inside surfaces of the rear glass substrate and front glass substrate constituting the liquid crystal panel module 303. A liquid crystal layer exists between the alignment films of the rear and front glass substrates. A polarization film is formed on the outside surfaces of the rear glass substrate and front glass substrate. The rear (or front) glass substrate is provided with a semiconductor switch for forming two-dimensionally arranged pixels, and a transparent electrode. The front (or rear) glass substrate is provided with a transparent common electrode.

FIG. 5A shows the state in which a white signal is input. At this time, the backlight light can pass through the liquid crystal panel module. This means that external light is applied to the backlight through the liquid crystal panel module. FIG. 5B shows the state in which a black signal is input. At this time, the backlight light cannot pass through the liquid crystal panel module.

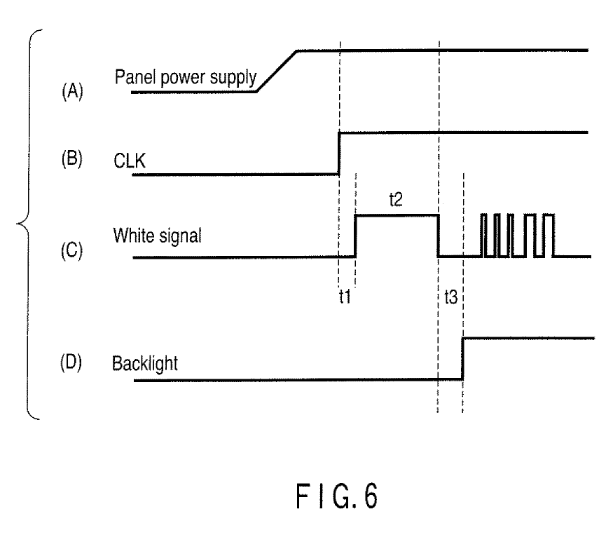

FIG. 6 is a diagram for explaining the characteristic operation of the apparatus of the present invention. FIG. 6 shows the operation timing of a panel power supply A, clock B, white signal C, and backlight D. An operation input for turning on the power supply is applied to the power supply module 410. The power supply module 410 turns on the timing pulse generation module 403, and outputs a panel source voltage from the first power supply circuit 4a. Then, the panel power supply A boots up. At this time, the signal processing module 404 turns on, and goes into a standby state.

Next, the timing pulse generation module 403 starts supplying a clock B to the X- and Y-drivers 405 and 406. After the time t1, the timing pulse generation module 403 controls the signal processing module 404. The signal processing module 404 outputs a white signal. After the white signal is continuously output for the time t2, the supply of clock B is stopped. Thereby, the liquid crystal panel module 303 is shielded to light (the period t3). Next, the second power supply circuit 4b is turned on by a timing pulse from the timing pulse generation module 403, and voltage is applied to the backlight unit 301 through the inverter circuit 411. Therefore, the fluorescent tubes of the backlight unit 301 are lit all together. Thereafter, a due displaying video signal is output from the signal processing module 404 by a control pulse from the timing pulse generation module 403. The above-mentioned time t2 is 500±100 msec in a current product. The period t3 is 0 to 100 ms, and is basically set by the product performance. These time and period are preferably set as short as possible.

By the above operation, particularly in the time t2 of a white signal, the liquid crystal panel module 303 is set to a state to permit transmission of external light. Therefore, external light is applied to the fluorescent tubes of the backlight being turned off. The gas contained the fluorescent tubes is activated. Therefore, when the fluorescent tubes are energized, electrons in the fluorescent tubes are activated, and the fluorescent tubes are smoothly lit. The cause of smooth lighting will be explained further hereinafter.

In the above description, the liquid crystal panel module 303 is assumed to be a normally black type.

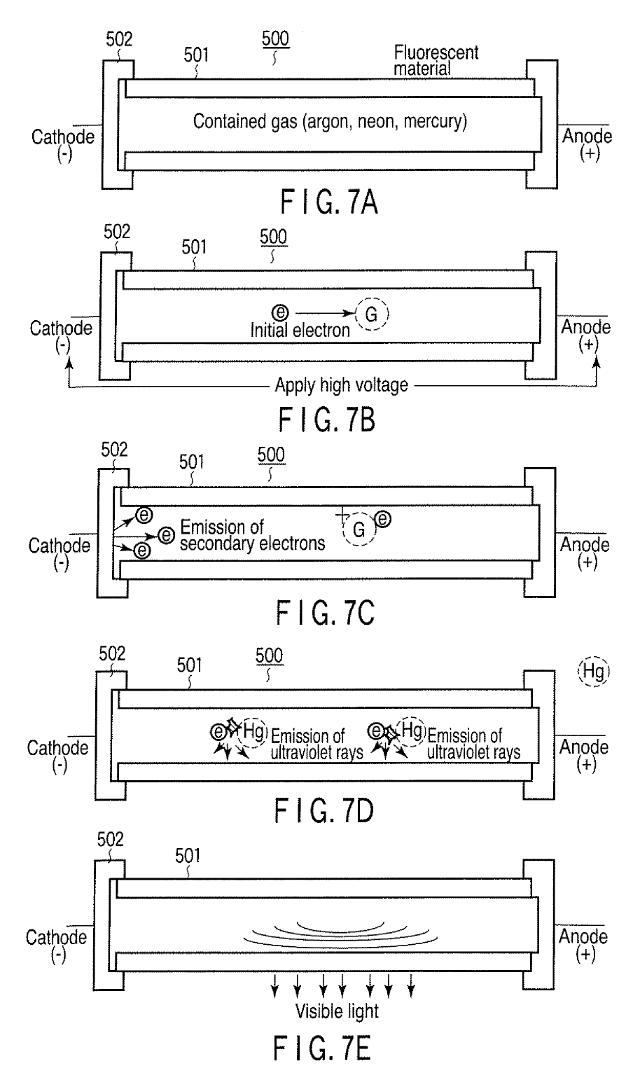

Next, an explanation will be given on the lighting operation of a fluorescent tube 500 by referring to FIGS. 7A to 7E. The fluorescent tube 500 basically has electrodes 502 and 503 at both ends of a cylindrical glass tube 501. Gas (e.g., argon, neon, or mercury) is contained in the tubular glass tube 501. The inside surface of the glass tube 501 is coated with fluorescent material (FIG. 7A).

A high voltage is applied over the electrodes 502 and 503 for lighting a fluorescent tube (FIG. 7B). Then, an initial electrode e from the substance to accelerate initial generation of electrons in a fluorescent tube collides with an atom of the contained gas (FIG. 7B). Thereby, a free electron+of the contained gas is emitted, attracted to the negative electrode 502, and collides with the electrode 502 (FIG. 7C). The electrode 502 emits a number of secondary electrodes 2 (FIG. 7C). The secondary electron 2 collides with the contained mercury Hg (FIG. 7D). Then, ultraviolet rays are emitted. The ultraviolet rays excite the fluorescent material, thereby providing a visible output light (FIG. 7E).

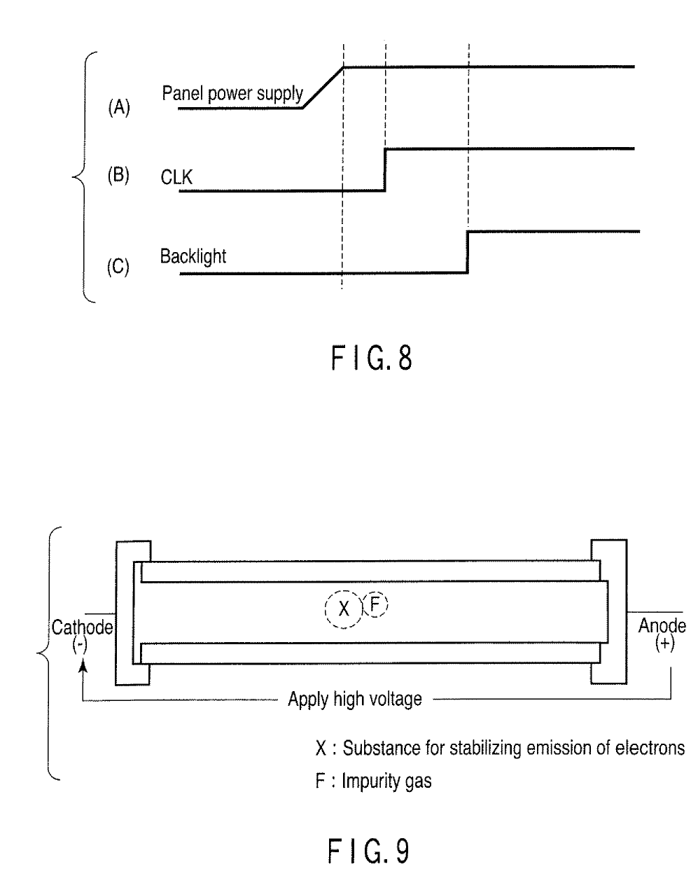

The fluorescent tube 500 is conventionally energized in a liquid crystal device at the timing shown in FIG. 8. First, the liquid crystal device is turned on (see the panel power supply A in FIG. 8). Then, a clock is supplied to the X- and Y-drivers 405 and 406 (see the clock B in FIG. 8). Next, the backlight unit is turned on (see the backlight C in FIG. 8). However, in this method of energization, the lighting of some fluorescent tubes is delayed, and the tubes are not lit as a result of the function of the protection circuit of the inverter circuit 411.

Studying the cause of the above problem, the following fact is found. For example, as shown in FIG. 9, impurity gas F may adhere to a substance X to accelerate initial generation of electrons. The substance X to accelerate initial generation of electrons is metal such as aluminum and cesium, or metal oxides such as indium oxide (In²O³). If the impurity gas F adheres to the substance X to accelerate initial generation of electrons, the capacity to accelerate initial generation of electrons is lowered, and causes the above problem (delayed lighting of some fluorescent tubes).

To solve the above problem, in the apparatus of the present invention, a photoelectric effect is produced by applying external light to the substance X to accelerate initial generation of electrons. The photoelectric effect means excitation of electrons in a substance when receiving external light, or pop-up of electrons, or generation of photoconduction or photoelectromotive force accompanying with the excitation of electrons. The present invention utilizes this phenomenon.

To produce a photoelectric effect, external light is guided for a certain period of time, and then the liquid crystal panel is closed (a state shielded to light), and the backlight unit is turned on. Namely, the liquid crystal device is energized in the sequence shown in FIG. 6. As shown in FIG. 6, the period t2 is the time to apply external light to a fluorescent tube. The period t3 is the time to once set the liquid crystal panel module to the light-shielded state. If the backlight unit is lit at a time while the liquid crystal panel module is being in the transmissive state, a screen glows like a flash.

As described above, in one embodiment of the invention, while a white signal is being supplied, an photoelectric effect is produced for a substance to accelerate initial generation of electrons in fluorescent tubes of a backlight, thereby facilitating initial emission of electrons, lighting fluorescent tubes all together at power-on, and eliminating a delay in lighting of some fluorescent tubes. Further, as the backlight is turned on after supply of a white signal is stopped, a stable image display is realized without a flashing phenomenon.

In the prior art, there is a technique to set an external light transmissive state by simply applying voltage to a liquid crystal device. However, the amount of applied external light is very small in this method. In contrast to the prior art, in the apparatus of the present invention, a white signal is positively supplied. Therefore, the whole screen is set to a state to transmit light by substantially 100%. Contrast of a liquid crystal device is 1000:1. Considering this fact, as a while signal is positively supplied by a white signal supply means, the amount of taken-in external Light is greatly increased compared with the prior art. Therefore, the apparatus of the present invention fully uses the function of the substance X to accelerate initial generation of electrons in a fluorescent tube, and increases the operation speed of a fluorescent tube.

While certain embodiments of the invention have been described, these embodiments have been presented by way of example only, and are not intended to limit the scope of the invention. Indeed, the novel method and system described herein may be embodied in a variety of other forms; furthermore, various omissions, substitutions and changes in the form of the method and system described herein may be made without departing from the spirit of the invention. The accompanying claims and their equivalents are intended to cover such forms or modifications as would fall within the scope and spirit of the invention.

What is claimed is:

1. A liquid crystal device driving apparatus comprising:
a first power supply module which turns on a normally black liquid crystal panel module or a normally white liquid crystal panel module;
a signal processing module which supplies a white signal to the liquid crystal panel module after the first power supply module turns on the liquid crystal panel module; and
a second power supply module which turns on a backlight, after the signal processing module stops supplying the white signal.

2. The liquid crystal device driving apparatus according to claim 1, wherein the backlight uses a fluorescent tube filled with a substance X to accelerate initial generation of electrons, which produces a photoelectric effect by applying external light.

3. The liquid crystal device driving apparatus according to claim 2, wherein the liquid crystal panel module constitutes a display module of a television apparatus or a personal computer.

4. The liquid crystal device driving apparatus according to claim 3, wherein the signal processing module supplies a due displaying video signal to the liquid crystal panel module, after turning on the backlight.

5. The liquid crystal device driving apparatus according to claim 3, wherein the second power supply module turns on the backlight in a fixed time period after the signal processing module stops supplying the white signal.

6. A method of driving a liquid crystal device having a first power supply module which turns on a normally black liquid crystal panel module or a normally white liquid crystal panel module; a second power supply module which turns on a backlight of the liquid crystal panel module; and a signal processing module which supplies a white signal to the liquid crystal panel module, the method of driving a liquid crystal device comprising:
turning on the liquid crystal panel module by a timing pulse;
supplying a white signal to the liquid crystal panel module; and
turning on a backlight after stopping supply of the white signal.

7. The method of driving a liquid crystal device according to claim 6, wherein the backlight uses a fluorescent tube filled with a substance X to accelerate initial generation of electrons, which produces a photoelectric effect by applying external light.
